(19) United States
(12) Patent Application Publication
(10) Pub. No.: US 2025/0350801 A1
(43) Pub. Date: Nov. 13, 2025

(54) IDENTIFYING CHANNEL FEATURE RECOMMENDATIONS FOR A CHANNEL MEMBERSHIP ON A CONTENT PLATFORM

(71) Applicant: Google LLC, Mountain View, CA (US)

(72) Inventors: Briana Yvonne Seiderman, Zurich (CH); Ludmila Danilescu, Zurich (CH); Martin Krivánek, Thalwil (CH); Shu Li, Zurich (CH); Silviu Bota, Horgen (CH); René Jonathan Vennik, Freienbach (CH)

(21) Appl. No.: 19/201,849

(22) Filed: May 7, 2025

Related U.S. Application Data
(60) Provisional application No. 63/645,819, filed on May 10, 2024.

(51) Int. Cl. H04N 21/466; H04N 21/266; H04N 21/431

(52) U.S. Cl. CPC H04N 21/4668; H04N 21/266; H04N 21/4312

(57) ABSTRACT

Systems and methods for identifying channel feature recommendations for a channel membership for presentation on a content platform are provided. A request pertaining to a creation of a channel membership for a channel is received from a channel owner of one or more channels. A plurality of engagement signals associated with the one or more channels of the channel owner is identified. A plurality of channel feature recommendations for the channel membership to be created for the channel is determined based on the plurality of engagement signals. A channel user interface (UI) of the content sharing platform is caused to be presented to the channel owner, the channel UI providing a first subset of the plurality of channel feature recommendations for the channel membership and one or more UI elements visually representing a customized selection of one or more of the first subset of the plurality of channel feature recommendations for the channel membership to be created for the channel.

### RELATED APPLICATIONS

This application claims the benefit of priority from U.S. Provisional Application No. 63/645,819, filed May 10, 2024, which is incorporated herein by reference.

### TECHNICAL FIELD

Aspects and implementations of the present disclosure relate to identifying channel feature recommendations for a channel membership for presentation on a content platform.

### BACKGROUND

A platform (e.g., a content platform) can transmit media items to client devices connected to the platform via a network. A media item can include an audio item or a video item, in some instances. Users can consume the transmitted media items via a user interface (UI) provided by the platform. In some instances, media items can be provided to users through channels. A channel can include content provided by a channel owner. A user can subscribe to the channel to gain access to the media items of the channel. In some instances, a channel owner can provide channel memberships offering various channel features, where a user can subscribe to the channel membership and gain access to the various channel features.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

An aspect of the disclosure provides a computer-implemented method that includes receiving, from a channel owner of one or more channels, by a processing device of a content sharing platform, a request pertaining to a creation of a channel membership for a channel of the one or more channels. The method further includes identifying a plurality of engagement signals associated with the one or more channels of the channel owner. The method further includes determining, based on the plurality of engagement signals, a plurality of channel feature recommendations for the channel membership to be created for the channel. The method further includes causing a channel user interface (UI) of the content sharing platform to be presented to the channel owner, the channel UI providing a first subset of the plurality of channel feature recommendations for the channel membership and one or more UI elements visually representing a customized selection of one or more of the first subset of the plurality of channel feature recommendations for the channel membership to be created for the channel.

In some implementations, the one or more UI elements are interactive to allow the channel owner to modify the customized selection or add a selection of another channel feature recommendation of the plurality of channel feature recommendations.

In some implementations, the method further includes determining, for each engagement signal of the plurality of engagement signals, a respective ranking; and causing the channel UI to provide a second subset of the plurality of offer recommendations, wherein the second subset of the plurality of offer recommendations is arranged in an order based on the respective ranking for each engagement signal of the plurality of engagement signals.

In some implementations, the method further includes determining one or more respective channel membership levels; and in response to receiving a selection of one or more of the plurality of channel feature recommendations, associating, based on the plurality of engagement signals and a number of selected channel feature recommendations, a first channel feature recommendation with a respective channel membership level.

In some embodiments, identifying the set of engagement signals further includes performing at least one of: (i) identifying a number of subscribers associated with the channel owner; (ii) identifying a geographic location of one or more subscribers associated with the channel owner; or (iii) identifying a type of content associated with the channel owner, wherein the type of content comprises at least one of: livestream media, short form media, or long form media.

In some implementations, determining, for each engagement signal of the plurality of engagement signals, the respective ranking further includes assigning a weight value to each engagement signal of the plurality of engagement signals.

In some implementations, the method further includes determining a fee associated with each of the one or more respective channel membership levels based on one or more of: a number of channel features included in a respective channel membership level, resources to be consumed to provide the respective channel membership level, time to be spent to implement the respective channel membership level, an estimated value of the respective channel membership level to subscribers, engagement signals with respect to fee recommendations previously provided to the channel owner, or existing membership level fees of channels of other channel owners, wherein the one or more UI elements of the channel UI displays the fee associated with each of the one or more respective channel membership levels.

An aspect of the disclosure provides a system including a memory device and a processing device communicatively coupled to the memory device. The processing device performs operations including receiving, from a channel owner of one or more channels, a request pertaining to a creation of a channel membership for a channel of the one or more channels. The processing device is to perform operations further including identifying a plurality of engagement signals associated with the one or more channels of the channel owner. The processing device is to perform operations further including determining, based on the plurality of engagement signals, a plurality of channel feature recommendations for the channel membership to be created for the channel. The processing device is to perform operations further including causing a channel user interface (UI) of the content sharing platform to be presented to the channel owner, the channel UI providing a first subset of the plurality of channel feature recommendations for the channel membership and one or more UI elements visually representing a customized selection of one or more of the first subset of the plurality of channel feature recommendations for the channel membership to be created for the channel.

In some implementations, the one or more UI elements are interactive to allow the channel owner to modify the customized selection or add a selection of another channel feature recommendation of the plurality of channel feature recommendations.

In some implementations, the processing device is to perform operations further including determining, for each engagement signal of the plurality of engagement signals, a respective ranking; and causing the channel UI to provide a second subset of the plurality of offer recommendations, wherein the second subset of the plurality of offer recommendations is arranged in an order based on the respective ranking for each engagement signal of the plurality of engagement signals.

In some implementations, the processing device is to perform operations further including determining one or more respective channel membership levels; and in response to receiving a selection of one or more of the plurality of channel feature recommendations, associating, based on the plurality of engagement signals and a number of selected channel feature recommendations, a first channel feature recommendation with a respective channel membership level.

In some embodiments, identifying the set of engagement signals further includes performing at least one of: (i) identifying a number of subscribers associated with the channel owner; (ii) identifying a geographic location of one or more subscribers associated with the channel owner; or (iii) identifying a type of content associated with the channel owner, wherein the type of content comprises at least one of: livestream media, short form media, or long form media.

In some implementations, determining, for each engagement signal of the plurality of engagement signals, the respective ranking further includes assigning a weight value to each engagement signal of the plurality of engagement signals.

In some implementations, the processing device is to perform operations further including determining a fee associated with each of the one or more respective channel membership levels, wherein the one or more UI elements of the channel UI displays the fee associated with each of the one or more respective channel membership levels.

An aspect of the disclosure provides a computer program including instructions that, when the program is executed by a processing device, cause the processing device to perform operations including receiving, from a channel owner of one or more channels, a request pertaining to a creation of a channel membership for a channel of the one or more channels. The processing device is to perform operations further including identifying a plurality of engagement signals associated with the one or more channels of the channel owner. The processing device is to perform operations further including determining, based on the plurality of engagement signals, a plurality of channel feature recommendations for the channel membership to be created for the channel. The processing device is to perform operations further including causing a channel user interface (UI) of the content sharing platform to be presented to the channel owner, the channel UI providing a first subset of the plurality of channel feature recommendations for the channel membership and one or more UI elements visually representing a customized selection of one or more of the first subset of the plurality of channel feature recommendations for the channel membership to be created for the channel.

In some implementations, the one or more UI elements are interactive to allow the channel owner to modify the customized selection or add a selection of another channel feature recommendation of the plurality of channel feature recommendations.

In some implementations, the processing device is to perform operations further including determining, for each engagement signal of the plurality of engagement signals, a respective ranking; and causing the channel UI to provide a second subset of the plurality of offer recommendations, wherein the second subset of the plurality of offer recommendations is arranged in an order based on the respective ranking for each engagement signal of the plurality of engagement signals.

In some implementations, the processing device is to perform operations further including determining one or more respective channel membership levels; and in response to receiving a selection of one or more of the plurality of channel feature recommendations, associating, based on the plurality of engagement signals and a number of selected channel feature recommendations, a first channel feature recommendation with a respective channel membership level.

In some embodiments, identifying the set of engagement signals further includes performing at least one of: (i) identifying a number of subscribers associated with the channel owner; (ii) identifying a geographic location of one or more subscribers associated with the channel owner; or (iii) identifying a type of content associated with the channel owner, wherein the type of content comprises at least one of: livestream media, short form media, or long form media.

In some implementations, determining, for each engagement signal of the plurality of engagement signals, the respective ranking further includes assigning a weight value to each engagement signal of the plurality of engagement signals.

In some implementations, the processing device is to perform operations further including determining a fee associated with each of the one or more respective channel membership levels, wherein the one or more UI elements of the channel UI displays the fee associated with each of the one or more respective channel membership levels.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 depicts a flow diagram of a method for identifying channel feature recommendations for a channel membership for presentation on a content platform, in accordance with implementations of the present disclosure.

FIG. 3A is a block diagram illustrating an example channel user interface (UI), in accordance with implementations of the present disclosure.

FIG. 3B is a block diagram illustrating another example channel user interface (UI), in accordance with implementations of the present disclosure.

FIG. 4 is a block diagram illustrating an exemplary computer system, in accordance with implementations of the present disclosure.

### DETAILED DESCRIPTION

Aspects of the present disclosure relate to identifying channel feature recommendations for a channel membership for presentation on a content platform.

A platform (e.g., a content sharing platform) can transmit media items to client devices connected to the platform via a network. A media item can include an audio item or a video item, in some instances. Users can consume the transmitted media items via a user interface (UI) provided by the platform. In some instances, media items can be provided to users through channels.

A channel can include content available from a common source and/or having a common topic or theme. A channel can be managed by the channel owner who can perform various management actions on the channel. Management actions may include, for example, adding media items to the channel, removing media items from the channel, defining subscription requirements for the channel, defining presentation attributes for channel content, defining access attributes for channel content, etc. The channel content can include media items uploaded to the content platform by the channel owner and/or media items selected by the channel owner from content available on the content platform. A channel owner can be, e.g., a professional content provider (e.g., a professional content creator, a professional content distributor, a content rental service, a television (TV) service, etc.), or an amateur individual. The channel content can include, e.g., professional content (e.g., movie clips, TV clips, music videos, educational videos) and/or amateur content (e.g., video blogging, short original videos, etc.).

Users of the platform can subscribe to one or more channels in which they are interested. Typically, subscribing to a channel provides users with free access to content (e.g., channel features) on the channel. In some instances, a channel owner may be interested in monetizing the channel by making some or all of the content (e.g., channel features) on the channel available to users who have a paid subscription to the channel (e.g., a channel membership). However, when creating a channel membership, the channel owner may not be able to select the channel features for offering to subscribers, such that the selected channel features would increase viewership of the channel and maximize the revenue-driving parameters of the channel. Further, when creating the channel membership, the channel owner may not be able to select the channel membership levels and fees of each level to offer to subscribers, such that the selected membership level and fee structure would increase viewership of the channel and maximize the revenue-driving parameters of the channel. As a result, system resources may be unnecessarily consumed by generating, transmitting, storing and presenting channel features and membership configurations that are not optimized for user engagement. For example, processing cycles, memory bandwidth, and storage may be used to support features or pricing tiers that fail to align with subscriber behavior, thereby reducing overall system efficiency and increasing computational overhead.

Implementations of the present disclosure address the above and other deficiencies by identifying and presenting to the channel owner the channel feature recommendations for creating a channel membership that is aligned with user engagement. The channel feature recommendations can be generated based on engagement signals of the channel to which the recommendations apply and/or engagement signals of other channel(s) owned by the owner of the channel to which the recommendations apply. In some implementations, the channel features recommendations may be also based on resources required to provide a respective channel feature, a time needed to implement the respective channel feature and/or a complexity of using the respective channel feature, as determined based on historical channel feature data.

The channel feature recommendations can include, for example, channel member loyalty badges, early access to content, channel members-only content, prioritization of channel owner's response to comments from channel members, channel members “shout-outs,” channel members status updates using media (e.g., images), channel members-only chat rooms, channel members-only social media connection with channel owner, channel members-only emojis, etc. In some embodiments, the engagement signals of a channel can include the number of subscribers of the channel owner, the geographic regions in which the subscribers of the channel reside, the age group of the subscribers of the channel, the content type of the channel owner, the media type of the channel owner (e.g., livestream content, short form media, long form media, etc.), etc.).

In some embodiments, the channel user interface (UI) can be presented to the channel owner. The channel UI can include a subset (e.g., a first subset) of channel feature recommendations, where each channel feature recommendation included in the subset is selected based on a respective ranking of the channel feature recommendation. For example, the highest ranked channel feature recommendations can be included in the subset of the set of channel feature recommendations. The channel UI can further include one or more UI elements that visually represent a customized selection (e.g., an auto-selection) of one or more of the subset of the set of channel feature recommendations. For example, the one or more UI elements can be boxes that are “checked off” to visually represent the customized selection of the one or more channel feature recommendations. The auto-selection of the channel feature recommendations can be based on the engagement signals pertaining to the channel and/or other channels of the channel owner. Alternatively, the auto-selection of the channel feature recommendations can be based on channel features used by channel owners that have similar audiences and/or provide content having similar characteristics with the content of the channel, as discussed in more details herein. The customized selection can be interactive (e.g., by the channel owner) to create the channel membership for the channel, e.g., by modifying the customized selection or by adding a selection of another channel feature recommendation to the customized selection).

In some embodiments, the channel UI can include another subset (e.g., a second subset) of the set of channel feature recommendations, where each channel feature recommendation included in the second subset is selected based on a respective ranking of the channel feature recommendation with respect to the channel and/or the channel owner. For example, the lower ranked channel feature recommendations (e.g., lower ranked compared to the respective rankings of the channel feature recommendations included in the first subset) can be included in the subset of the set of channel feature recommendations. The order of the channel feature recommendations in the first and second subsets can be based on respective rankings.

In some embodiments, one or more channel membership levels can be recommended to the channel owner (e.g., by automatically creating different combinations of channel features). The number of recommended channel membership levels can be determined based on the number of channel feature recommendations, analysis of engagement signals with respect to recommendations previously provided to the channel owner (usually selects a more or less conservative approach), analysis of existing membership levels of channels of other channel owners, etc. In some embodiments, the channel UI can present the one or more channel membership levels to the channel owner. The channel UI can further include one or more UI elements that visually represent a customized selection (e.g., an auto-selection) of a channel membership level of the one or more channel membership levels. The customized selection can be interactive (e.g., by the channel owner) to create the channel membership for the channel, e.g., by modifying the customized selection to select another channel membership level of the one or more channel membership levels.

In some embodiments, a fee to be offered for each of the one or more respective channel membership levels can be recommended to the channel owner. The fee can be calculated based on the number of channel features included in the channel membership level, resources needed/consumed to provide a respective channel membership level, time needed to implement the respective channel membership level, estimated value of the respective channel membership level to subscribers, analysis of engagement signals with respect to fee recommendations previously provided to the channel owner (usually selects a more or less conservative approach), analysis of existing membership level fees of channels of other channel owners, etc. In some embodiments, the channel UI can present the fee for each of one or more respective channel membership levels to the channel owner. The channel UI can further include one or more UI elements that visually represent a customized selection of the fee that is offered for a respective channel membership level of the one or more respective channel membership levels. The customized selection can be interactive (e.g., by the channel owner) to modify the fee offered for the respective channel membership level.

Thus, aspects of the present disclosure provide technical advantages over previous solutions. Aspects of the present disclosure can provide an automated tool for identifying channel feature recommendations for creating a channel membership for a particular channel. The automated tool can align with subscriber engagement behavior by taking into account the engagement signals of the particular channel and/or other channel owned by the owner of the particular channel. As a result, system resources are efficiently consumed by generating, transmitting, storing and presenting channel features and membership configurations that are optimized for user engagement. In particular, processing cycles, memory bandwidth, and storage are used to support features or pricing tiers that align with subscriber behavior, thereby increasing overall system efficiency and increasing computational overhead. Furthermore, providing UIs that assist channel creators in their selections of channel features and channel membership levels allows channel creators to make more informed and accurate selections, thereby reducing the likelihood of implementing suboptimal membership configurations. As a result, the system avoids unnecessary consumption of computing resources associated with maintaining and processing low-performing channel configurations.

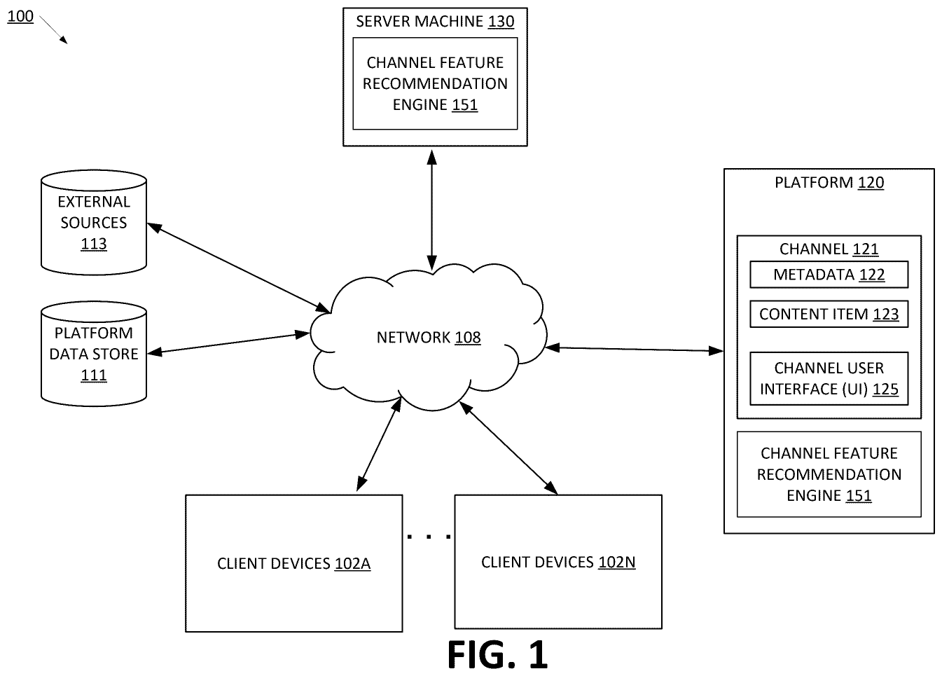

FIG. 1 illustrates an example system 100, in accordance with implementations of the present disclosure. The system 100 includes user devices 102A-N, a platform data store 111, a platform 120, and/or server machine 130, each connected to a network 108. In some implementations, network 108 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, platform data store 111 can be a persistent storage capable of storing data as well as data structures to tag, organize, and index the platform data. In some implementations, a data item of platform data can correspond to one or more portions of a content item for display to a content viewer via a graphical user interface (GUI) on a viewing user device 102, in accordance with implementations described herein. A data item can correspond to metadata for a content item, such as a content item title, transcript, description, length, or content item viewing statistics. In some implementations, a data item of platform data can correspond to one or more portions of a channel, including channel metadata such as a channel title, channel description, channel uploading user, or channel viewing statistics. Platform data store 111 can be hosted by one or more storage devices, such as main memory, magnetic or optical storage-based disks, tapes or hard drives, NAS, SAN, and so forth. In some implementations, platform data store 111 can be a network-attached file server, while in other implementations the platform data store 111 can be some other type of persistent storage such as an object-oriented database, a relational database, and so forth, that may be hosted by platform 120 or one or more different machines coupled to the platform 120 via network 108.

The client devices 102A-N can each include computing devices such as personal computers (PCs), laptops, mobile phones, smartphones, tablet computers, netbook computers, network-connected televisions, etc. Each client device 102 can include a content viewer. In some implementations, a content viewer can be an application that provides a user interface (UI) for users to view or upload content, such as images, video items, web pages, documents, etc. For example, the content viewer can be a web browser that can access, retrieve, present, and/or navigate content (e.g., web pages such as Hyper Text Markup Language (HTML) pages, digital content items, etc.) served by a web server. The content viewer can render, display, and/or present the content to a user. The content viewer can also include an embedded media player (e.g., a Flash® player or an HTML5 player) that is embedded in a web page (e.g., a web page that may provide information about a product sold by an online merchant). In another example, the content viewer can be a standalone application (e.g., a mobile application or app) that allows users to view digital content items (e.g., digital video items, digital images, electronic books, etc.). According to aspects of the disclosure, the content viewer can be a content platform application for users to record, edit, and/or upload content for sharing on platform 120. As such, the content viewers and/or the UI associated with the content viewer can be provided to client devices 102A-N by platform 120. In one example, the content viewers can be embedded media players that are embedded in web pages provided by the platform 120.

Platform 120 can include one or more channels 121. A channel 121 can include metadata 122 associated with the channel 121, and one or more content items 123 available from a common source, or content items 123 having a common topic, theme, or substance. Metadata 122 can include various information pertinent to the channel 121, such as a title, description, date, usage statistics, or content language. In some implementations, metadata 122 can include information about the one or more content items 123 of channel 121. For example, metadata 122 can include information about content item 123, such as a title, description, date, identity of channel owner, usage statistics, or language.

A channel 121 can represent one or more content item 123 (e.g., digital content) chosen by a user, digital content made available by a user, digital content uploaded by a user, digital content chosen by a content provider, digital content chosen by a broadcaster, etc. For example, a channel X can include videos Y and Z. A channel can be associated with a channel owner, who is a user that can perform actions on the channel. Different activities can be associated with the channel 121 based on the channel owner's actions, such as the channel owner making digital content available on the channel 121, the channel owner selecting (e.g., liking) digital content associated with another channel 121, the channel owner commenting on digital content associated with another channel 121, etc. The activities associated with the channel 121 can be collected into an activity feed for the channel 121. Users, other than the owner of the channel 121, can subscribe to one or more channels 121 in which they are interested. The concept of “subscribing” may also be referred to as “liking,” “following,” “friending,” and so on.

Client devices 102A-N include client devices of channel owners of channels 121 and client devices of other users that view content items 123 and/or subscribe to channels 121.

A content item 123 can be consumed via the Internet or via a mobile device application, such as a content viewer of viewing client devices 102A-N. In some implementations, a content item 123 can correspond to a media file (e.g., a video file, an audio file, a video stream, an audio stream, etc.). In other or similar implementations, a content item 123 can correspond to a portion of a media file (e.g., a portion or a chunk of a video file, an audio file, etc.). As discussed previously, a content item 123 can be requested for presentation to the user by the user of the platform 120. As used herein, “content item” can include an electronic file that can be executed or loaded using software, firmware or hardware configured to digitally present the content item to an entity. As indicated above, in at least one implementation, the platform 120 can store the content items 123, or references to the content items 123, using the platform data store 111. In some implementations, the platform 120 can store the content item 123 or fingerprints as electronic files in one or more formats using platform data store 111.

In some implementations, content item 123 can be a video item. A video item refers to a set of sequential video frames (e.g., image frames) representing a scene in motion. For example, a series of sequential video frames can be captured continuously or later reconstructed to produce animation. Video items can be provided in various formats including, but not limited to, analog, digital, two-dimensional and three-dimensional video. Further, video items can include movies, video clips, video streams, or any set of images (e.g., animated images, non-animated images, etc.) to be displayed in sequence. In some implementations, a video item can be stored (e.g., at platform data store 111) as a video file that includes a video component and an audio component. The video component can include video data that corresponds to one or more sequential video frames of the video item. The audio component can include audio data that corresponds to the video data.

In some implementations, server machine 130 can host a channel feature recommendation engine 151 that generates channel feature recommendations pertaining to a channel membership for a channel of a channel owner. The channel feature recommendations can be generated based on engagement signals of the channel to which the recommendations apply and/or engagement signals of other channel(s) owned by the owner of the channel to which the recommendations apply. The channel feature recommendations can include, for example, channel member loyalty badges, early access to content, channel members-only content, prioritization of channel owner's response to comments from channel members, channel members “shout-outs,” channel members status updates using media (e.g., images), channel members-only chat rooms, channel members-only social media connection with channel owner, channel members-only emojis, etc. In some embodiments, the engagement signals of a channel can include the number of subscribers of the channel owner, the geographic regions in which the subscribers of the channel reside, the age group of the subscribers of the channel, the content type of the channel owner, the media type of the channel owner (e.g., livestream content, short form media, long form media, etc.), etc.).

In some embodiments, the channel feature recommendation engine 151 provides a channel UI 125 for presentation to a channel owner (e.g., on client devices 102-102N of channel owners). The channel UI 125 can include a subset of channel feature recommendations, where each channel feature recommendation included in the subset is selected based on a respective ranking of the channel feature recommendation. For example, the highest ranked channel feature recommendations can be included in the subset of the set of channel feature recommendations. The channel UI 125 can further include one or more UI elements that visually represent a customized selection (e.g., an auto-selection) of one or more of the subset of the set of channel feature recommendations. For example, the one or more UI elements can be boxes that are “checked off” to visually represent the customized selection of the one or more channel feature recommendations. The customized selection can be interactive (e.g., by the channel owner) to create the channel membership for the channel, e.g., by modifying the customized selection or by adding a selection of another channel feature recommendation to the customized selection.

In some embodiments, the channel UI 125 can include another subset of channel feature recommendations, where each channel feature recommendation included in the second subset is selected based on a respective ranking of the channel feature recommendation. For example, the lower ranked channel feature recommendations (e.g., lower ranked compared to the respective rankings of the channel feature recommendations included in the first subset) can be included in the subset of the set of channel feature recommendations.

In some embodiments, the channel UI 125 can present one or more channel membership levels to the channel owner. The channel UI 125 can further include one or more UI elements that visually represent a customized selection (e.g., an auto-selection) of a channel membership level of the one or more channel membership levels. The customized selection can be interactive (e.g., by the channel owner) to create the channel membership for the channel, e.g., by modifying the customized selection to select another channel membership level of the one or more channel membership levels.

In some embodiments, the channel UI 125 can present a fee for each respective channel membership level to the channel owner. The channel UI can further include one or more UI elements that visually represent a customized selection of the fee that is offered for a respective channel membership level of the one or more respective channel membership levels. The customized selection can be interactive (e.g., by the channel owner) to modify the fee offered for the respective channel membership level.

In some implementations, platform 120 and/or server machine 130 can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components. Platform 120 can include channel 121. Channel 121 can be made accessible through platform 120. In some implementations, platform 120 can facilitate the access of channel 121, or information about channel 121 through channel user interface (UI) 125.

In some implementations, the functions of server machine 130 or platform 120 may be provided by a fewer number of machines. For example, in some implementations, the server machine 130 can be integrated into platform 120. In some implementations, the server machine 130 can be integrated separately from platform 120. In addition, the functionality attributed to a specific component can be performed by different or multiple components operating together. Platform 120 can also be accessed as a service provided to other systems or devices through appropriate application programming interfaces, and thus is not limited to use in websites.

In situations in which the systems discussed here collect personal information about users, or may make use of personal information, the users may be provided with an opportunity to control whether platform 120 collects user information (e.g., information about a user's social network, social actions or activities, profession, a user's preferences, or a user's current location), or to control whether and/or how to receive content from the server 130 that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the platform 120 and/or server 130.

In various implementations of the disclosure, a “user” can be represented by a single individual. However, other implementations of the disclosure encompass a “user” being an entity controlled by a group of individuals and/or an automated source. For example, a group of individuals federated as a community in a social network can be considered a “user.” Further to the descriptions above, a user can be provided with controls allowing the user to make an election as to both if and when systems, programs, or features described can enable collection of user information (e.g., information about a user's social network, social actions, or activities, profession, a user's preferences, or a user's current location), and if the user is sent content or communications from a server. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over what information is collected about the user, how that information is used, and what information is provided to the user.

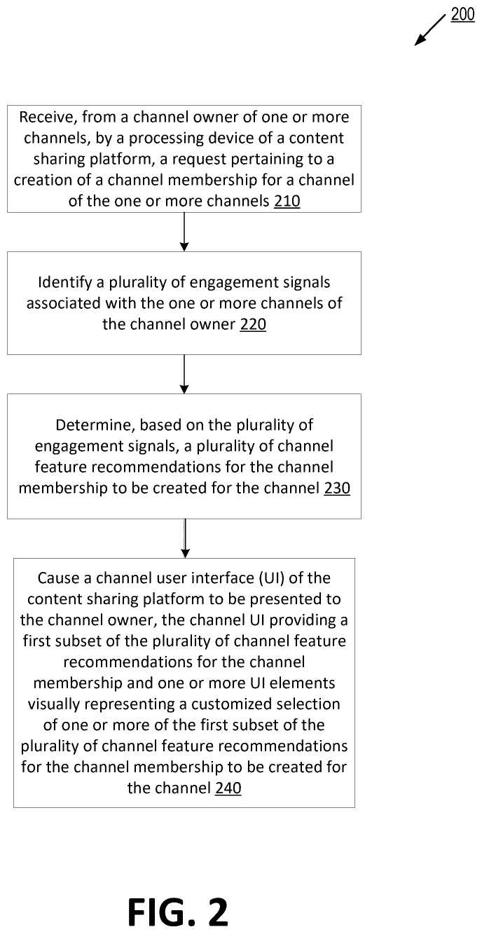

FIG. 2 depicts a flow diagram of a method for identifying channel feature recommendations for a channel membership for presentation on a content platform, in accordance with implementations of the present disclosure. Method 200 may be performed by processing logic that may include hardware (circuitry, dedicated logic, etc.), software (e.g., instructions run on a processing device), or a combination thereof. In one implementation, some or all the operations of method 200 may be performed by one or more components of system 100 of FIG. 1 (e.g., platform 120, server(s) 130, and/or channel feature recommendation engine 151).

For simplicity of explanation, the method 200 of this disclosure is depicted and described as a series of acts. However, acts in accordance with this disclosure can occur in various orders and/or concurrently, and with other acts not presented and described herein. Furthermore, not all illustrated acts may be required to implement the method 200 in accordance with the disclosed subject matter. In addition, those skilled in the art will understand and appreciate that the method 200 could alternatively be represented as a series of interrelated states via a state diagram or events. Additionally, it should be appreciated that the method 200 disclosed in this specification are capable of being stored on an article of manufacture (e.g., a computer program accessible from any computer-readable device or storage media) to facilitate transporting and transferring such method to computing devices. The term “article of manufacture,” as used herein, is intended to encompass a computer program accessible from any computer-readable device or storage media.

At block 210, the processing logic receives, from a channel owner of one or more channels of a content platform (e.g., platform 120 of FIG. 1), a request pertaining to a creation of a channel membership recommendation for a channel of the one or more channels. In some implementations, the channel can be associated with content items (e.g., content item 123 of FIG. 1) and/or metadata (e.g., metadata 122 of FIG. 1).

At block 220, the processing logic identifies a set of engagement signals associated with the one or more channels of the channel owner. For example, the processing logic can retrieve the set of engagement signals from a data store associated with the platform 120 (e.g., the platform data store 111 of FIG. 1). In an illustrative example, the set of engagement signals can include the number of subscribers to a channel of the channel owner. In another illustrative example, the set of engagement signals can include a geographic region in which one or more subscribers of the channel resides. In another illustrative example, the set of engagement signals can include the age group of one or more subscribers of the channel. In another illustrative example, the set of engagement signals can include the content subject type offered by the channel owner (e.g., lifestyle, travel, cooking, etc.). In another illustrative example, the set of engagement signals can include the media type of the channel owner (e.g., livestream media, short form media, long form media, etc.). Platform 120 can collect data about channels (channels 121), process it into different types of engagement signals (e.g., a number of channel subscribers, geographic regions of channel subscribers, age groups of channel subscribers, channel content subject types, media types of channel content, etc.).

At block 230, the processing logic can determine a set of channel feature recommendations for the channel membership to be created for the channel. The channel feature recommendations can include, for example, channel member loyalty badges, early access to content, channel members-only content, prioritization of channel owner's response to comments from channel members, channel members “shout-outs,” channel members status updates using media (e.g., images), channel members-only chat rooms, channel members-only social media connection with channel owner, channel members-only custom emojis, video collaborations between the channel owner and a channel member, virtual meet-and-greet between the channel owner and a channel member, exclusive merchandise, game play with the channel owner, behind-the-scenes content (e.g., videos), rough cuts and/or bloopers of content, wallpapers that are exclusive to one or more channels of the channel owner and/or channel owner, discounted merchandise of the channel owner, access to archived content (e.g., videos, livestreams, etc.), default channel member badges, channel members-only polls, etc.

In some embodiments, the processing logic can determine the set of channel feature recommendations based on the identified set of engagement signals. For example, the processing logic can assign a weight value to each engagement signal of the set of engagement signals. In some embodiments, the weight value can be determined for each engagement signal based on one or more inputs provided by a channel owner. For example, a UI can be provided to a channel owner listing channel features and allowing the channel owner to select or otherwise specify a rank and/or a weight value for each channel feature based on what they consider most to least difficult and/or based on what they consider to require the most to least amount of effort. Additionally or alternatively, the UI can also allow the channel owner to state subjectively how they view a particular channel feature and an estimate of how much the subscribers would pay (e.g., as a fee) for access to the channel feature.

Upon assigning the weight values to each engagement signal of the set of engagement signals, the processing logic can rank each engagement signal of the set of engagement signals according to the weighted values of respective engagement signals.

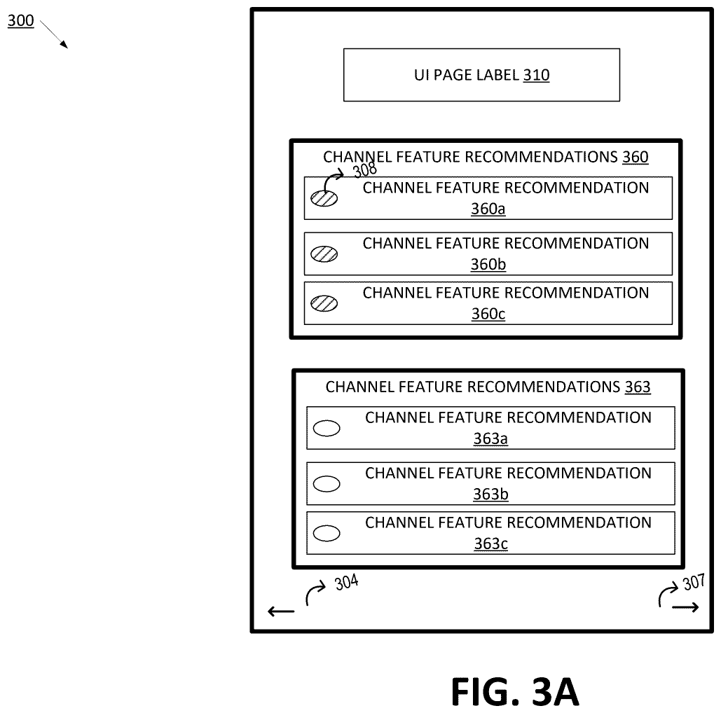

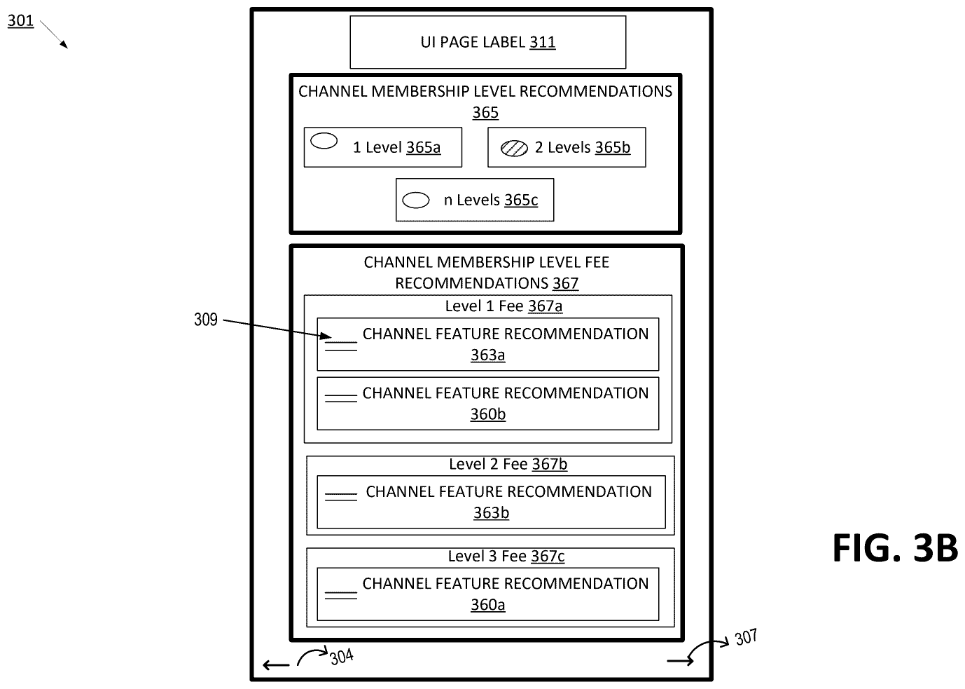

At block 240, the processing logic causes a channel user interface (UI) of the content sharing platform (e.g., the channel UI 125 of FIG. 1 and/or channel UI 300 of FIG. 3) to be presented to the channel owner. The channel UI can include a subset (e.g., a first subset) of the set of channel feature recommendations, where each channel feature recommendation included in the subset is selected based on a respective ranking of the channel feature recommendation. For example, the highest ranked channel feature recommendations can be included in the subset of the set of channel feature recommendations. The channel UI can further include one or more UI elements that visually represent a customized selection of one or more of the subset of the set of channel feature recommendations. For example, the one or more UI elements can be boxes that are “checked off” to visually represent the customized selection of the one or more channel feature recommendations. The customized selection can be interactive (e.g., by the channel owner) to create the channel membership for the channel, e.g., by modifying the customized selection or by adding a selection of another channel feature recommendation to the customized selection).

In some embodiments, the channel UI can include another subset (e.g., a second subset) of the set of channel feature recommendations, where each channel feature recommendation included in the second subset is selected based on a respective ranking of the channel feature recommendation. For example, the lower ranked channel feature recommendations (e.g., lower ranked compared to the respective rankings of the channel feature recommendations included in the first subset) can be included in the subset of the set of channel feature recommendations.

In some embodiments, one or more channel membership levels can be recommended to the channel owner. In some embodiments, the recommended channel membership levels can be determined based on testing using data analysis, where the recommended channel membership levels (e.g., the number of channel membership levels to offer) are dependent on the selected number of channel features for the channel membership. In some embodiments, the channel UI can present the one or more channel membership levels to the channel owner. The channel UI can further include one or more UI elements that visually represent a customized selection of a channel membership level of the one or more respective channel membership levels. The customized selection can be interactive (e.g., by the channel owner) to create the channel membership for the channel, e.g., by modifying the customized selection to select another channel membership level of the one or more respective channel membership levels.

In some embodiments, a fee that is offered for each of the one or more respective channel membership levels can be recommended to the channel owner. In some embodiments, the recommended fee for each channel membership level can be determined based on input of subscribers. For example, a UI can be provided to subscribers, listing channel features and allowing them to specify how they view a particular channel feature and how much the subscribers would pay (e.g., as a fee) for access to the channel feature. Accordingly, the recommended fee for each channel feature can be determined using the subscriber input.

In some implementations, the recommended fee for a particular channel membership level can be determined by computing a sum of the recommended fees for each channel feature included in the particular channel membership level. In some embodiments, the channel UI can present the fee for each of one or more respective channel membership levels to the channel owner. The channel UI can further include one or more UI elements that visually represent a customized selection of the fee that is offered for a respective channel membership level of the one or more respective channel membership levels. The customized selection can be interactive (e.g., by the channel owner) to modify the fee offered for the respective channel membership level.

In an illustrative example, referring to FIG. 3A, the processing logic can cause the channel UI 300 to be presented to the channel owner. The channel UI 300 can include a UI page label 310 (e.g., an identifier of the UI page, such as “Channel Memberships,” “Memberships,” “Choose Channel Features,” “Choose Perks,” etc.), a UI element 304 (e.g., a back button that can be selectable to go back to a previous page in the channel UI 300), a UI element 307 (e.g., a forward button that can be selectable to go forward to a subsequent page in the channel UI 300), a display area for a subset of channel feature recommendations 360, a display area for another subset of channel feature recommendations 363, where each subset of channel feature recommendations 360, 363 includes a set of channel feature recommendations (e.g., 360a-360c, 363a-363c) and one or more UI elements 308 that can visually represent a customized selection of one or more channel feature recommendations of each of the subsets of channel feature recommendations 360, 363.

In an illustrative example, referring to FIG. 3B, in response to receiving a customized selection of one or more channel feature recommendations (e.g., in the channel UI 300 of FIG. 3A), the processing logic can cause the channel UI 301 to be presented to the channel owner. The channel UI 300 can include a UI page label 311 (e.g., an identifier of the UI page, such as “Choose Levels,” “Choose Fees,” etc.), a UI element 304 (e.g., a back button that can be selectable to go back to a previous page in the channel UI 300), a UI element 307 (e.g., a forward button that can be selectable to go forward to a subsequent page in the channel UI 300), a display area for a set of channel membership level recommendations 365, a display area for a set of channel membership level fee recommendations 367, where the set of channel membership level recommendations 365 includes a set of levels (e.g., 1 level 365a, 2 levels 365b, n levels 365c) and one or more UI elements that can visually represent a customized selection of one or more levels of the set of levels. In some embodiments, the set of channel membership level fee recommendations 367 includes one or more of the channel feature recommendations of the customized selection of the one or more channel feature recommendations, where each of the channel feature recommendations can be visually associated with a corresponding level fee (e.g., level 1 fee 367a includes channel feature recommendation 363a, 360b, level 2 fee 367b includes channel feature commendation 363b, level 3 fee 367c includes channel feature recommendation 360a). In some embodiments, each channel feature recommendation can be associated with one or more UI elements 309 that can be selectable to toggle (e.g., move) one or more of the channel feature recommendations from a particular level to another particular level.

Further referring to FIG. 3A, the channel UI 300 allows a channel owner to choose channel features that they would like to offer to their subscribers based on channel feature recommendations 360 and 363. The channel feature recommendations 360 and 363 can be listed in the order that is determined based on rankings and/or weights discussed above. To assist the channel owner with their selection, the channel UI 300 may initially show, as selected as channel feature recommendations 360, channel features (e.g., loyalty badges, early access to videos, members-only videos and priority reply to comments) that a similar channel owner offers (or has previously offered) to their subscribers. The similar channel owner may be a channel owner that has similar channel characteristics (e.g., a similar number of channel subscribers, similar geographic regions of channel subscribers, similar age groups of channel subscribers, similar channel content subject types, similar media types of channel content, etc.). The channel UI 300 can allow the channel owner to keep the same features without needing to provide any input or to remove at least some of these features (e.g., by unchecking respective boxes 308). The channel UI 300 can also allow the channel owner to add more features using channel feature recommendations 363 which may include, for example, providing member-only shorts (brief video clips that are quick (e.g., last from a few seconds to a few minutes), engaging, and easily consumable), member shout-outs, photos and status updates, connecting on social media, members-only live chats, emoji, etc. Channel feature recommendations 363 may have lower rankings for the channel owner than channel feature recommendations 360.

Once the channel feature recommendations are selected, the channel owner can proceed to the channel UI 301 FIG. 3B, that can list different channel membership level recommendations 365 and corresponding membership level fee recommendations 367. For example, three channel membership levels can be recommended, where the first channel membership level 365a can be recommended for channel features selected by the channel owner in UI 300 (e.g., loyalty badges, early access to videos, members-only videos and priority reply to comments), the second channel membership level recommendation 365b can include fewer channel features (e.g., only loyalty badges and early access to videos) and/or different combination of channel features, etc. The channel UI 301 can also present different membership level fee recommendations 367. For example, a recommended monthly membership fee for level 1 can be 3.99 US dollars, a recommended monthly membership fee can be 2.99 US dollars. The channel owner can change their selection of channel features in UI 300 of FIG. 3A using UI elements 308, and/or remove or add features to different membership levels in UI 301 of FIG. 3B using UI elements 309. In response, the UI 301 may dynamically present different membership level fee recommendations 367 for new selections of the channel owner.

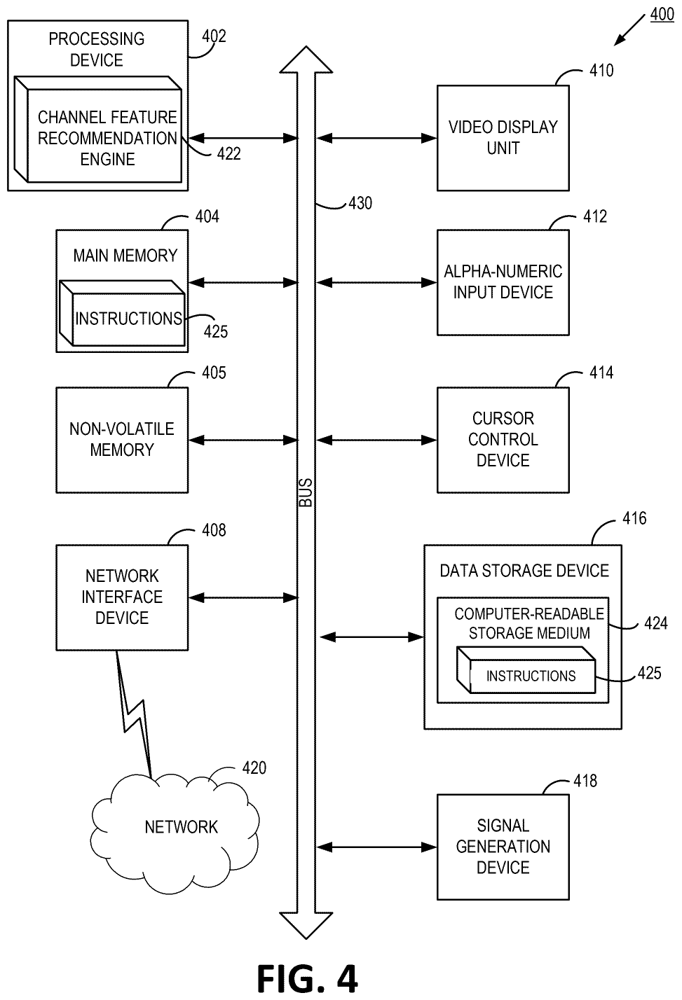

FIG. 4 is a block diagram illustrating an exemplary computer system, in accordance with implementations of the present disclosure. The computer system 400 can be the server 130, 133, and/or 150 or client devices 102A-N in FIG. 1. The machine can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processing device (processor) 402, a main memory 404 (e.g., read-only memory (ROM), flash memory, dynamic random access memory (DRAM) such as synchronous DRAM (SDRAM), double data rate (DDR SDRAM), or DRAM (RDRAM), etc.), a static memory 406 (e.g., flash memory, static random access memory (SRAM), etc.), and a data storage device 418, which communicate with each other via a bus 440.

Processor (processing device) 402 represents one or more general-purpose processing devices such as a microprocessor, central processing unit, or the like. More particularly, the processor 402 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 402 can also be one or more special-purpose processing devices such as an application specific integrated circuit (ASIC), a field programmable gate array (FPGA), a digital signal processor (DSP), network processor, or the like. The processor 402 is configured to execute instructions 405 (e.g., for identifying channel feature recommendations for a channel membership for presentation on a content platform) for performing the operations discussed herein.

The computer system 400 can further include a network interface device 408. The computer system 400 also can include a video display unit 410 (e.g., a liquid crystal display (LCD) or a cathode ray tube (CRT)), an input device 412 (e.g., a keyboard, and alphanumeric keyboard, a motion sensing input device, touch screen), a cursor control device 414 (e.g., a mouse), and a signal generation device 420 (e.g., a speaker).

The data storage device 418 can include a non-transitory machine-readable storage medium 424 (also computer-readable storage medium) on which is stored one or more sets of instructions 405 (e.g., for identifying channel feature recommendations for a channel membership for presentation on a content platform) embodying any one or more of the methodologies or functions described herein. The instructions can also reside, completely or at least partially, within the main memory 404 and/or within the processor 402 during execution thereof by the computer system 400, the main memory 404 and the processor 402 also constituting machine-readable storage media. The instructions can further be transmitted or received over a network 430 via the network interface device 408.

In one implementation, the instructions 405 include instructions for identifying channel feature recommendations for a channel membership for presentation on a content platform. While the computer-readable storage medium 424 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics may be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user may opt-in or opt-out of participating in such data collection activities. In one implementation, the collect data is anonymized prior to performing any analysis to obtain any statistical patterns so that the identity of the user cannot be determined from the collected data.

What is claimed is:

1. A method comprising:
receiving, from a channel owner of one or more channels, by a processing device of a content sharing platform, a request pertaining to a creation of a channel membership for a channel of the one or more channels;
identifying a plurality of engagement signals associated with the one or more channels of the channel owner;
determining, based on the plurality of engagement signals, a plurality of channel feature recommendations for the channel membership to be created for the channel; and
causing a channel user interface (UI) of the content sharing platform to be presented to the channel owner, the channel UI providing a first subset of the plurality of channel feature recommendations for the channel membership and one or more UI elements visually representing a customized selection of one or more of the first subset of the plurality of channel feature recommendations for the channel membership to be created for the channel.

2. The method of claim 1, wherein the one or more UI elements are interactive to allow the channel owner to modify the customized selection or add a selection of another channel feature recommendation of the plurality of channel feature recommendations.

3. The method of claim 1, further comprising:
determining, for each engagement signal of the plurality of engagement signals, a respective ranking; and
causing the channel UI to provide a second subset of the plurality of offer recommendations, wherein the second subset of the plurality of offer recommendations is arranged in an order based on the respective ranking for each engagement signal of the plurality of engagement signals.

4. The method of claim 1, further comprising:
determining one or more respective channel membership levels; and
in response to receiving a selection of one or more of the plurality of channel feature recommendations, associating, based on the plurality of engagement signals and a number of selected channel feature recommendations, a first channel feature recommendation with a respective channel membership level.

5. The method of claim 1, wherein identifying the plurality of engagement signals further comprises performing at least one of:
(i) identifying a number of subscribers associated with the channel owner;
(ii) identifying a geographic location of one or more subscribers associated with the channel owner; or
(iii) identifying a type of content associated with the channel owner, wherein the type of content comprises at least one of: livestream media, short form media, or long form media.

6. The method of claim 3, wherein determining, for each engagement signal of the plurality of engagement signals, the respective ranking further comprises:
assigning a weight value to each engagement signal of the plurality of engagement signals.

7. The method of claim 3, further comprising:
determining a fee associated with each of the one or more respective channel membership levels based on one or more of: a number of channel features included in a respective channel membership level, resources to be consumed to provide the respective channel membership level, time to be spent to implement the respective channel membership level, an estimated value of the respective channel membership level to subscribers, engagement signals with respect to fee recommendations previously provided to the channel owner, or existing membership level fees of channels of other channel owners, wherein the one or more UI elements of the channel UI displays the fee associated with each of the one or more respective channel membership levels.

8. A system comprising:
a memory device; and
a processing device coupled to the memory device, the processing device to perform operations comprising:
receiving, from a channel owner of one or more channels of a content sharing platform, a request pertaining to a creation of a channel membership for a channel of the one or more channels;
identifying a plurality of engagement signals associated with the one or more channels of the channel owner;
determining, based on the plurality of engagement signals, a plurality of channel feature recommendations for the channel membership to be created for the channel; and
causing a channel user interface (UI) of the content sharing platform to be presented to the channel owner, the channel UI providing a first subset of the plurality of channel feature recommendations for the channel membership and one or more UI elements visually representing a customized selection of one or more of the first subset of the plurality of channel feature recommendations for the channel membership to be created for the channel.

9. The system of claim 8, wherein the one or more UI elements are interactive to allow the channel owner to modify the customized selection or add a selection of another channel feature recommendation of the plurality of channel feature recommendations.

10. The system of claim 8, wherein the processing device is to perform operations further comprising:
determining, for each engagement signal of the plurality of engagement signals, a respective ranking; and
causing the channel UI to provide a second subset of the plurality of offer recommendations, wherein the second subset of the plurality of offer recommendations is arranged in an order based on the respective ranking for each engagement signal of the plurality of engagement signals.

11. The system of claim 8, wherein the processing device is to perform operations further comprising:
determining one or more respective channel membership levels; and
in response to receiving a selection of one or more of the plurality of channel feature recommendations, associating, based on the plurality of engagement signals and a number of selected channel feature recommendations, a first channel feature recommendation with a respective channel membership level.

12. The system of claim 8, wherein to identify the plurality of engagement signals, the processing device is to perform operations further comprising:
(i) identifying a number of subscribers associated with the channel owner;
(ii) identifying a geographic location of one or more subscribers associated with the channel owner; or
(iii) identifying a type of content associated with the channel owner, wherein the type of content comprises at least one of: livestream media, short form media, or long form media.

13. The system of claim 10, wherein to determine, for each engagement signal of the plurality of engagement signals, the respective ranking, the processing device is to perform operations further comprising:
assigning a weight value to each engagement signal of the plurality of engagement signals.

14. The system of claim 10, wherein the processing device is to perform operations further comprising:
determining a fee associated with each of the one or more respective channel membership levels based on one or more of: a number of channel features included in a respective channel membership level, resources to be consumed to provide the respective channel membership level, time to be spent to implement the respective channel membership level, an estimated value of the respective channel membership level to subscribers, engagement signals with respect to fee recommendations previously provided to the channel owner, or existing membership level fees of channels of other channel owners, wherein the one or more UI elements of the channel UI displays the fee associated with each of the one or more respective channel membership levels.

15. A non-transitory computer readable storage medium comprising instructions for a server that, when executed by a processing device, cause the processing device to perform operations comprising:
receiving, from a channel owner of one or more channels of a content sharing platform, a request pertaining to a creation of a channel membership for a channel of the one or more channels;
identifying a plurality of engagement signals associated with the one or more channels of the channel owner;
determining, based on the plurality of engagement signals, a plurality of channel feature recommendations for the channel membership to be created for the channel; and
causing a channel user interface (UI) of the content sharing platform to be presented to the channel owner, the channel UI providing a first subset of the plurality of channel feature recommendations for the channel membership and one or more UI elements visually representing a customized selection of one or more of the first subset of the plurality of channel feature recommendations for the channel membership to be created for the channel.

16. The non-transitory computer readable storage medium of claim 15, wherein the processing device is to perform operations further comprising:
determining, for each engagement signal of the plurality of engagement signals, a respective ranking; and
causing the channel UI to provide a second subset of the plurality of offer recommendations, wherein the second subset of the plurality of offer recommendations is arranged in an order based on the respective ranking for each engagement signal of the plurality of engagement signals.

17. The non-transitory computer readable storage medium of claim 15, wherein the processing device is to perform operations further comprising:
determining one or more respective channel membership levels; and
in response to receiving a selection of one or more of the plurality of channel feature recommendations, associating, based on the plurality of engagement signals and a number of selected channel feature recommendations, a first channel feature recommendation with a respective channel membership level.

18. The non-transitory computer readable storage medium of claim 15, wherein to identify the plurality of engagement signals, the processing device is to perform operations further comprising:
(i) identifying a number of subscribers associated with the channel owner;
(ii) identifying a geographic location of one or more subscribers associated with the channel owner; or
(iii) identifying a type of content associated with the channel owner, wherein the type of content comprises at least one of: livestream media, short form media, or long form media.

19. The non-transitory computer readable storage medium of claim 17, wherein to determine, for each engagement signal of the plurality of engagement signals, the respective ranking, the processing device is to perform operations further comprising:
assigning a weight value to each engagement signal of the plurality of engagement signals.

20. The non-transitory computer readable storage medium of claim 17, wherein the processing device is to perform operations further comprising:
determining a fee associated with each of the one or more respective channel membership levels based on one or more of: a number of channel features included in a respective channel membership level, resources to be consumed to provide the respective channel membership level, time to be spent to implement the respective channel membership level, an estimated value of the respective channel membership level to subscribers, engagement signals with respect to fee recommendations previously provided to the channel owner, or existing membership level fees of channels of other channel owners, wherein the one or more UI elements of the channel UI displays the fee associated with each of the one or more respective channel membership levels.
